(19) United States
(12) Patent Application Publication
(10) Pub. No.: US 2009/0080421 A1
(43) Pub. Date: Mar. 26, 2009

(54) DATA FLOW MIRRORING

(76) Inventor: Frank Y. Ou, Fremont, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 12/233,472

(22) Filed: Sep. 18, 2008

Related U.S. Application Data
(60) Provisional application No. 60/974,443, filed on Sep. 21, 2007.

(51) Int. Cl. H04L 12/56

(52) U.S. Cl. 370/389

(57) ABSTRACT

A network switch having flow-mirroring capabilities. A first port is provided for communicating data items, each associated with a particular data flow, over a network. A number of data ports are switchably connected to the first port for enabling the data items to be communicated between the first port and at least one of the data ports. A second port is provided for selectively outputting a copy of one or more of the data items based on the associated data flows.

### CROSS-REFERENCE TO RELATED APPLICATIONS

This application claims priority to U.S. Provisional Application No. 60/974,443 filed Sep. 21, 2007, entitled “Remote VLAN Mirroring”, which is hereby incorporated by reference in its entirety.

### TECHNICAL FIELD

The disclosure herein relates generally to network systems, and more specifically to monitoring specific data flows within such network systems.

### BACKGROUND

Port mirroring is a common feature of network switches. In general, port mirroring enables data traffic at a given port of the switch to be copied (i.e., “mirrored”) onto a designated mirroring port. This allows a user to effectively monitor all of the data traffic being received and/or output via the given port without affecting the actual data that is communicated through the network. For example, a network administrator may wish to monitor the mirrored data traffic for purposes of testing and/or maintaining the network.

FIG. 1 illustrates a typical network system 100 with port mirroring. The network system 100 is made up of two network switches 110 and 120, connected to one another via a network infrastructure 150. For purposes of illustration, the network infrastructure 150 is shown as an “internet cloud”, however it should be noted that the network infrastructure 150 may include any additional devices of the network system 100 used in facilitating data transfers between the network switch 110 and the network switch 120 (e.g., routers, hubs, switches, repeaters, and/or terminals). Switch 110 is connected to the network infrastructure 150 via a network port (PortA) for transmitting data to switch 120. A number of client devices 101-104 are connected to respective data ports (not shown) on the switch 11O. Switch 120 is connected to the network infrastructure 150 via a network port (PortB) for receiving data from switch 110. Switch 120 further includes a mirroring port (m.PortB) which provides a copy of all data transmitted and/or received at PortB of switch 120. A test apparatus 130 is connected to m.PortB of switch 120 for analyzing or performing diagnostics using the copied data.

Data received at each of the devices 101-104 is typically multiplexed onto PortA, of switch 110, for output to the network. Accordingly, the data traffic received at PortB, of switch 120, typically includes data from multiple client devices. For example, assuming all of the data output at PortA is successfully transmitted to PortB, the data traffic at PortB will include data from each of the client devices 101-104. Standard port mirroring further provides a copy of the data from each of the client devices 101-104 to the test apparatus 130, via m.PortB. This may present a number of issues regarding user privacy. For example, a network administrator that is granted access to monitor only a specific user data (e.g., from client device 101), in fact, has access to all user data (e.g., from client devices 101-104) at the mirroring port of switch 120.

There thus remains a need to enable only selective monitoring of user data traffic through a network system while ensuring the privacy of others.

### BRIEF DESCRIPTION OF THE DRAWINGS

The disclosure herein is illustrated by way of example, and not by way of limitation, in the figures of the accompanying drawings and in which like reference numerals refer to similar elements and in which:

FIG. 1 illustrates a typical network system with port mirroring;

FIG. 2 illustrates a network system, according to an embodiment;

FIG. 3 illustrates a network switch, according to an embodiment;

FIG. 4 illustrates an operation of a network switch, according to an embodiment;

FIG. 5 illustrates a network system, according to another embodiment;

FIG. 6 illustrates a network switch, according to another embodiment; and

FIG. 7 illustrates an operation of a network switch, according to another embodiment.

### DETAILED DESCRIPTION

In embodiments disclosed herein, a network switch is provided which facilitates selective monitoring of data traffic through a network. In an embodiment, a network switch includes a mirroring port that outputs a mirrored copy of only a selected data flow. In another embodiment, a network switch re-encapsulates a selected data flow to be transmitted over the network with a unique flow identifier. For purposes of discussion, “data” and “data traffic” may be used herein interchangeably. Furthermore, the terms “network interface device” and “interface device” may also be used interchangeably. It should be noted that a “network port,” as used herein, refers to a communications port on a network switch that is connected to the network. On the other hand, a “data port,” as used herein, refers to a communications port that is connected to a network interface device or end user terminal. It will be appreciated by one of ordinary skill in the art that a network port may alternatively be used as a data port, and vice-versa.

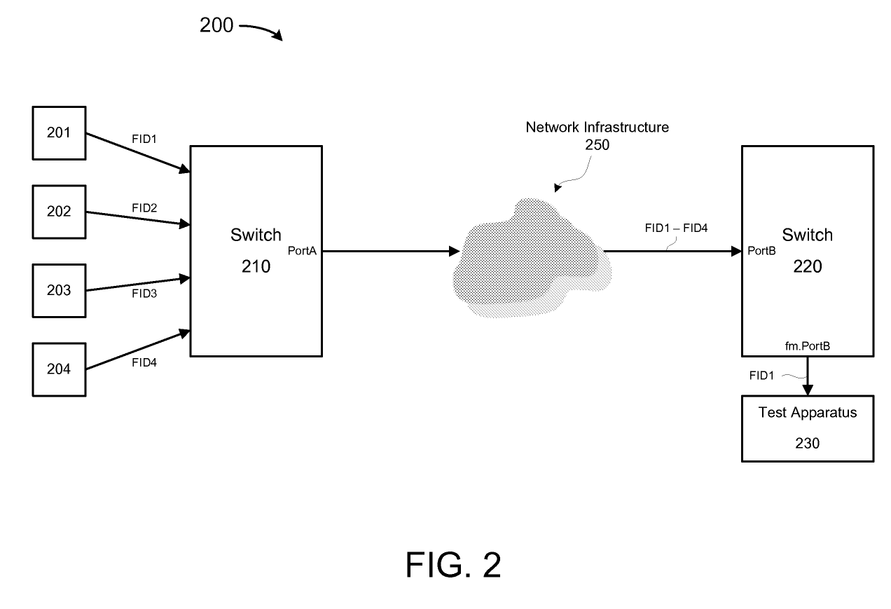

FIG. 2 illustrates a network system 200, according to an embodiment. The network system 200 is made up of two network switches 210 and 220, connected to one another via a network infrastructure 250. The network infrastructure 250 may include any additional devices (not specifically shown) used in facilitating data transfers between the network switch 210 and the network switch 220 (e.g., routers, hubs, switches, repeaters, and/or terminals).

The network switch 210 is connected to a number of network interface devices 201-204, via respective data ports of the switch 210 (not shown). A network interface device may be, for example, a computer terminal in which data transfers originate and/or terminate over the network. Data received from each of the interface devices 201-204 is multiplexed at a network port (PortA) for output to the network infrastructure 250.

The network switch 220 is connected to the network infrastructure 250 via a network port (PortB). As will be discussed in greater detail below, switch 220 includes a flow-mirroring port (fm.PortB) which outputs a copy of a particular data flow received at PortB. A test apparatus 230 is connected to fm.PortB of switch 220 for analyzing or performing diagnostic tests using the copied data. The test apparatus 230 may be, for example, a device used to measure and/or display performance parameters of the network system 200.

For purposes of discussion, it is assumed that the data transmitted by each of the devices 201-204 corresponds to a different “data flow”. A data flow logically distinguishes each of the multiplexed data items (e.g., data packets) based on a given criteria. In an example, a network interface device is automatically associated with a particular data flow based on the data port, of the switch 210, to which it is connected. In another example, each of the network interface devices 201-204 may be assigned a respective data flow according to a “virtual” network to which it belongs (e.g., based on each device's association with a corporate, government, and/or university network).

A data flow is identified according to flow identification information provided with the data packets of a particular network interface device. In other words, data packets originating from each of the network interface devices 201-204 are “encapsulated” (i.e., written or encoded) with corresponding flow identification information (FID1-FID4, respectively). Examples of such flow identification information may include, but are not limited to: an Internet Protocol (IP) address, a Media Access Control (MAC) address, Virtual Local Area Network (VLAN) information, Provider Backbone Transport (PBT) and/or other tunneling information. Alternatively, the data packets may be encapsulated with proprietary flow identification information (e.g., encoded into the payload and/or headers of the data packets).

In an embodiment, the switch 220 receives data from each of the network interface devices 201-204 at PortB and outputs a mirrored copy of the data from only one of the network interface devices (e.g., device 201) via fm.PortB. For example, the switch 220 may be configured to identify the flow identification information provided with each of the data packets and selectively output mirrored copies of only those data packets associated with a particular data flow.

It should be noted that, the switch 220 may be configured to selectively output a mirrored copy of data from multiple network interface devices, with little or no modification to the embodiments discussed herein. For example, data packets originating from multiple interface devices (e.g., devices 201 and 203) may be encapsulated with the same flow identification information (e.g., FID1). On the other hand, switch 220 may be configured to output a copy of multiple data flows via its flow-mirroring port. It should also be noted that, although data is shown flowing primarily in one direction (e.g., from the devices 201-204 to the switch 220), communications between each of the network elements may additionally be bidirectional. For example, the switches 210 and 220 may both transmit and receive data over the network infrastructure 250 (e.g., via the network ports PortA and PortB, respectively).

The network system 200 provides many advantages over the typical network system 100. For example, the test apparatus 230 may access a copy of only a specified data flow (e.g., depending on the rights of a network administrator to monitor the selected data flow) while, at the same time, ensuring the privacy of data traffic from all other network interface devices (e.g., devices 202-204).

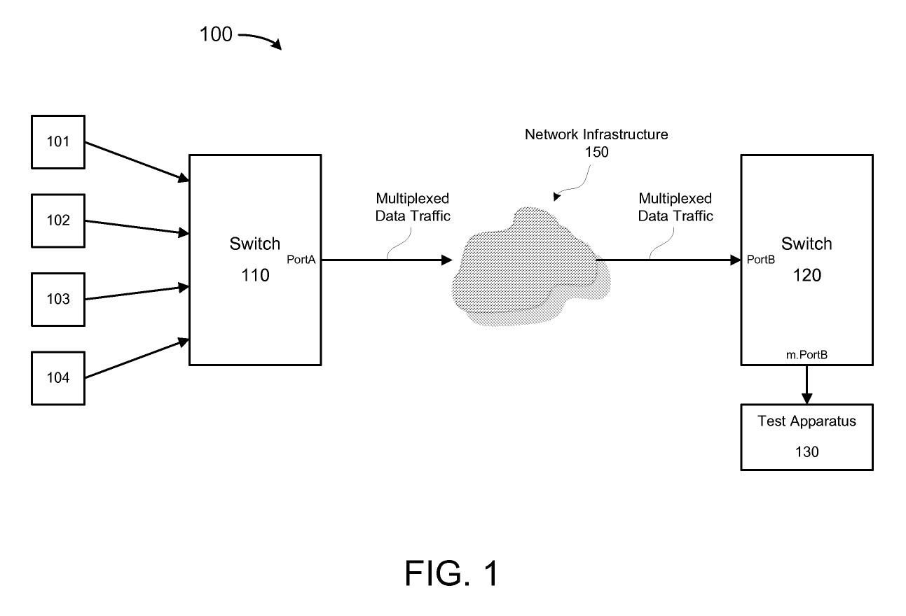

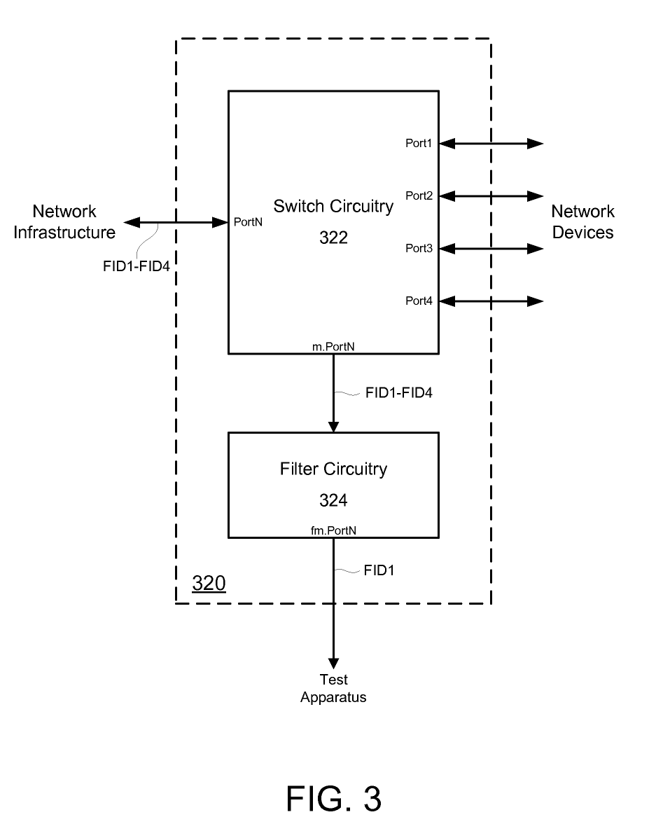

FIG. 3 illustrates a network switch 320, according to an embodiment. The network switch 320 is made up of switch circuitry 322 and filter circuitry 324. The switch circuitry 322 includes a network port (PortN) for communicating data over a network infrastructure, as well as a number of data ports (Port1-Port4) that are “switchably” connected to PortN (i.e., the switch circuitry 322 may bridge a connection between PortN and a selected one of the Ports-14) for communicating data between respective network devices. The network devices may include, for example, interface devices at which data communications originate and/or terminate. The network devices may additionally include routers, switches, and/or other elements used in facilitating the transfer of data to its final destination (e.g., one or more additional network segments). The switch circuitry 322 further includes a mirroring port (m.PortN) which outputs a copy of all data traffic at PortN. It should be noted that, for purposes of discussion, the data traffic at PortN is logically divided into multiple data flows (e.g., FID1-FID4). According to an embodiment, the switch circuitry 322 may be implemented using a typical network switch with port mirroring functionality (e.g., switch 120 of FIG. 1). It should be noted that the network switch 220 may include fewer or more data ports and/or network ports than shown.

The filter circuitry 324 is connected to the mirroring port of the switch circuitry 322, to receive a mirrored copy of all data traffic at PortN and output the copy of only a selected data flow via a flow-mirroring port (fm.PortN). For example, the filter circuitry 324 may be configured to identify data packets according to flow identification information. The filter circuitry 324 may filter all data packets not having the specified flow identification information, thus leaving only the selected data flow for output at fm.PortN (e.g., FID1). According to an embodiment, the filter circuitry 324 is field-programmable gate array (FPGA) which may be programmed to selectively output one of the mirrored data flows. Alternatively, the filter circuitry 324 may be configured to output multiple selected data flows.

In operation, a network administrator may be prompted to specify the precise flow identification information for which to monitor (e.g., this information may need to be provided by an end user associated with the data flow). Alternatively, a request to monitor a data flow may be embedded within a data packet of the given data flow. For example, an end user may transmit a request to have their particular data flow monitored (e.g., the request may be written to the payload and/or headers of a data packet). The filter circuitry 324 may then identify the specified request, along with the corresponding flow identification information included with the data packet.

It will be appreciated that the network switch 320 provides several advantages over a typical network switch (e.g., switch 120). For example, by leveraging the port mirroring functionality, the network switch 320 may be implemented on top of existing network switch architectures with very little modification. Furthermore, the programmability of the filter circuitry 324 provides the network administrator and/or end user with a certain degree of flexibility with regard to data flow monitoring, while still maintaining the privacy of other user data in the network.

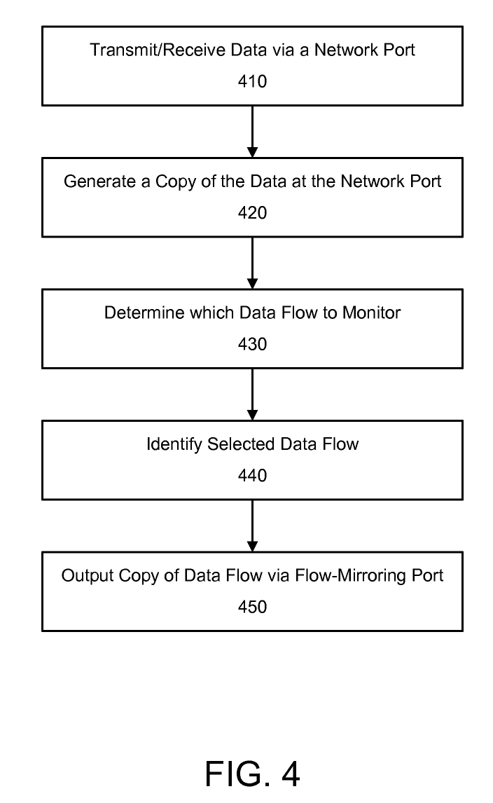

FIG. 4 illustrates an operation of a network switch, according to an embodiment. At 410, data traffic is transmitted and/or received over a network infrastructure, via a network port of the switch. At 420, the network switch generates a copy of the data traffic at the given network port. It should be noted that the incoming and/or outgoing data may be copied as soon as it is presented at the network port (i.e., steps 410 and 420 may be performed concurrently).

Then at 430, the network switch determines which data flow, of the copied data traffic, to monitor. According to an embodiment, the network switch may be manually configured to monitor a given data flow. For example, an end user may request to have their data flow monitored (e.g., for identifying or troubleshooting network performance) by indicating the flow identification information, associated with the particular end user's data flow, to a network administrator. The network administrator may then program the network switch to identify the end user's data flow. According to another embodiment, the network switch may identify a request to monitor a particular data flow from the copy of the data flow itself. For example, the end user may transmit a data packet with a monitoring request encoded in it. The network switch may interpret the monitoring request along with the associated flow identification information from the data packet, and automatically configure itself to identify the corresponding data flow.

At 440, the network switch identifies the selected data flow from the copied data traffic, and outputs a copy of only those data packets associated with the selected data flow at 450. For example, the network switch may parse each of the copied data packets for the specified flow identification information (e.g., IP address, MAC address, VLAN information, and/or tunneling information) and/or filter all of the copied data packets not having the particular flow identification information. According to an embodiment, multiple data flows may be identified at 440, and subsequently output at 450.

It may be assumed, in the example above, that all of the data traffic provided at the network port is first copied (e.g., at step 420) and subsequently filtered (e.g., steps 430-450). Thus, it should be noted that the foregoing operation of a network switch, as described with respect to FIG. 4, may be implemented by the network switch 320, of FIG. 3. However, it should also be noted that the order in which data is copied or filtered may be arbitrary. For example, the step of generating a copy of the data traffic at the network port (i.e., step 420) may instead be performed after the step of identifying the selected data flow (e.g., from the actual data traffic). In other words, the network switch may generate a copy of only those data packets identified for the selected data flow.

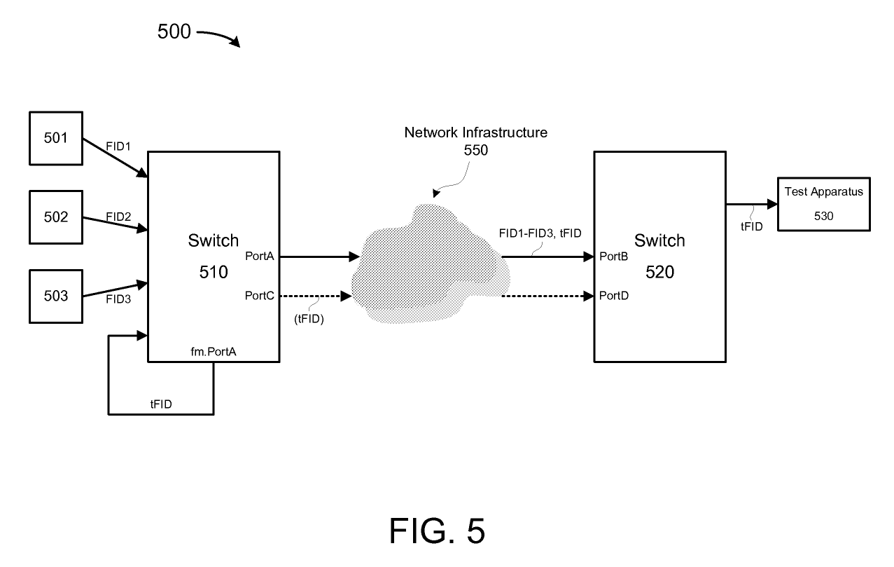

FIG. 5 illustrates a network system 500, according to another embodiment. The network system 500 is made up of two network switches 510 and 520, connected to one another via a network infrastructure 550. The switch 510 is connected to a number of network interface devices 501-503, via respective data ports of the switch 510 (not shown). A network interface device may be, for example, a computer terminal in which data transfers originate and/or terminate over the network. Data received from each of the interface devices 501-503 is multiplexed at a network port (PortA) for output to the network infrastructure 550. Switch 510 includes a flow-mirroring port (fm.PortA) which outputs a copy of a particular data flow output at PortA. The output at fm.PortA is further connected to a data port of switch 510, thus enabling the copied data flow to be transmitted over the network. The switch 520 is connected to the network infrastructure 550 via a network port (PortB). A test apparatus 530 is connected to a data port (not shown) of switch 520. As will be described in greater detail below, the test apparatus is provided for analyzing or performing diagnostic tests using the copied data flow. The test apparatus 530 may be, for example, a device used to measure and/or display performance parameters of the network system 500.

The network switch 510 transmits data from each of the network interface devices 501-504 at PortB and outputs a mirrored copy of the data from only one of the network interface devices (e.g., device 501) via a flow-mirroring port (fm.PortB). For example, the switch 510 may be configured to identify the flow identification information provided with each of the data packets and selectively output mirrored copies of only those data packets associated with a particular data flow. The copied data flow is fed back into a data port of the switch 510 and transmitted to the network infrastructure 550. For example, the copied data flow may be multiplexed with the rest of the data traffic at PortA (e.g., from network devices 501-503), for output over the network infrastructure 550.

According to an embodiment, the copied data flow is re-encapsulated with new flow identification information (tFID) prior to being transmitted over the network. For example, the new flow identification information may be automatically assigned to the copied data flow based on the data port, of switch 510, which the copied data flow is fed back into. Alternatively, the new flow identification information may be programmatically determined (e.g., based on user-defined parameters or a set of runtime parameters determined by the network switch 510), and thus the network switch 510 may encode the copied data flow with the new flow identification information prior to its output at fm.PortA.

It should be noted that the re-encapsulated data flow (tFID) may or may not trace the same path, through the network infrastructure 550, as the remaining data flows (FID1-FID3). Thus, in an alternative embodiment, rather than being multiplexed for output with the other data flows (e.g., at PortA), the re-encapsulated data flow may be output via a separate network port of the network switch 510 (e.g., PortC). The re-encapsulated data flow may then be transmitted, via the network infrastructure 550, to the network switch 520 (alternatively, the re-encapsulated data flow may be output directly to the test apparatus 530). Similarly, the network switch 520 may receive the re-encapsulated data flow (tFID) at a different network port (e.g., PortD) than the network port at which the other data flows are received (i.e., PortB). For example, the data path(s), through the network infrastructure 550, between PortC and PortD may be dedicated to the transfer of re-encapsulated data flows for monitoring and/or testing purposes.

The test apparatus 530 is connected to the network switch 520 to receive the copied data flow from the network infrastructure 550. For example, the new flow identification information (tFID) may identify the test apparatus 530 as the destination (e.g., based on a destination address included with the new flow identification information) for each packet of the copied data flow. Thus, the test apparatus 530 may be connected to a standard data port of the network switch 520. It should be noted that the network switch 520 may simply direct all data packets of the copied data flow to the test apparatus 530, in the same manner as it would typically direct any data traffic to reach its corresponding destination. On the other hand, network switch 520 may simply be configured to transfer all data traffic received at a particular network port (e.g., PortD) to the test apparatus 530.

It should be noted that the network switch 510 may be configured to output mirrored copies of multiple data flows. For example, multiple copied data flows may be re-encapsulated using the same flow identification information (i.e., tFID). Alternatively, each of the selected data flows may be re-encapsulated with different flow identification information. Although data is shown to flow primarily in one direction (e.g., from the devices 501-503 to the switch 520), communications between each of the network elements may additionally be bidirectional. For example, the network switches 510 and 520 may both transmit and receive data over the network infrastructure 550 (e.g., via the network ports, PortA and PortB, respectively).

According to an embodiment, data traffic is output from PortB of switch 520 and subsequently received at PortA of switch 510. Of the data traffic received at PortA, a selected data flow is thus copied and re-encapsulated with new flow identification information (e.g., tFID) by switch 510. The re-encapsulated data flow is then output from fm.PortA and input to a data port of the switch 510, and subsequently transmitted to the test apparatus 530. For example, the re-encapsulated data flow may be transmitted back to the network switch 520 via a dedicated data path (e.g., from PortC of switch 510 to PortD of switch 520). This dedicated path may be pre-tested and/or configured to ensure a certain level of quality for communications along it, thus providing a more robust means for communicating the re-encapsulated data flow. Alternatively, the re-encapsulated data flow may be transmitted to the test apparatus 530 directly (e.g., circumventing the network switch 520 entirely). This enables the test apparatus 530 to monitor the data received at the network switch 510, which may be useful in analyzing properties of the network system 500. More specifically, this may be useful in determining the network quality and/or performance experienced by one or more of the network devices 501-503.

The network system 500 may provide advantages over the network system 200, as it requires no input or configuring at the host end (e.g., at switch 520). In other words, a network administrator has little or no control over which data flows they are able to monitor through the test apparatus 530, thus ensuring a greater level of privacy for all data communications through the network. A further advantage of the network system 500 is that it provides for centralized monitoring of all data traffic communicated across the network (e.g., in both directions). In other words, a single test apparatus 530 is capable of monitoring both upstream data traffic (e.g., transmitted from switch 510 and received by switch 520) as well as downstream data traffic (e.g., transmitted from switch 520 and received by switch 510).

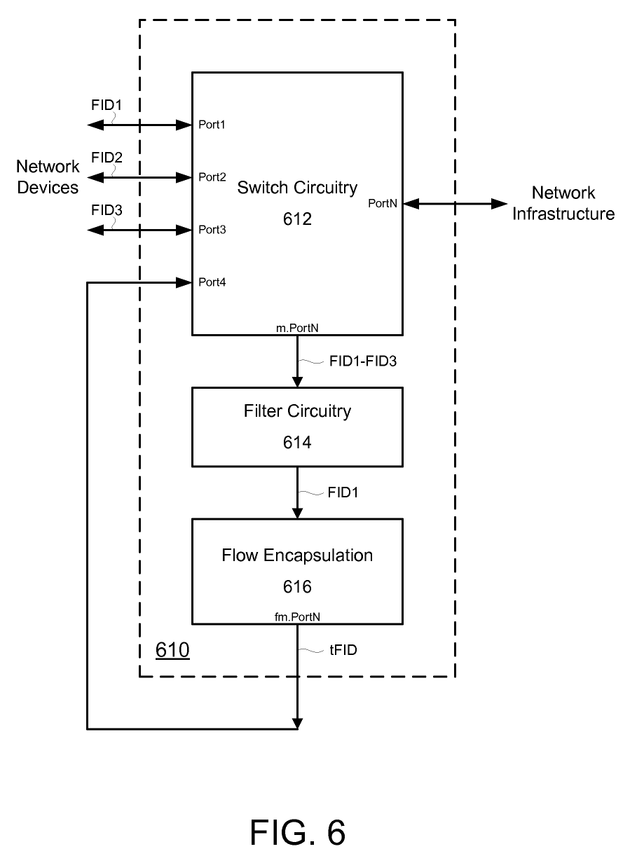

FIG. 6 illustrates a network switch 610, according to another embodiment. The network switch 610 is made up of switch circuitry 612, filter circuitry 614, and flow encapsulation circuitry 616. The switch circuitry 612 includes a network port (PortN) for communicating data over a network infrastructure, as well as a number of data ports (Port1-Port3) that are switchably connected to PortN for communicating data between respective network devices. It should be noted that, for purposes of discussion, the data traffic provided at each of the data ports (Port1-Port3) corresponds to a different data flow (e.g., FID1-FID3, respectively). The network devices may include, for example, interface devices at which data communications originate and/or terminate. The network devices may additionally include routers, switches, and/or other elements used in facilitating the transfer of data to its final destination (e.g., one or more additional network segments). The switch circuitry 612 further includes a mirroring port (m.PortN) which outputs a copy of all data traffic at PortN. According to an embodiment, the switch circuitry 612 may be implemented using a typical network switch with port mirroring functionality (e.g., switch 120 of FIG. 1). It should be noted that the switch circuitry 612 may include fewer or more data ports and/or network ports than shown.

The filter circuitry 614 is connected to the mirroring port of the switch circuitry 612, to receive a mirrored copy of all data traffic at PortN and output the copy of only a selected data flow. For example, the filter circuitry 614 may be configured to identify data packets according to flow identification information. The filter circuitry 614 may filter all data packets not having the specified flow identification information, thus leaving only the selected data flow for output (e.g., FID1). According to an embodiment, the filter circuitry 614 is a FPGA which may be programmed to selectively output any of the data flows (FID1-FID3). For example, the filter circuitry 614 may be manually programmed to identify the precise flow identification information for which to monitor. Alternatively, a request to monitor a data flow may be embedded within a data packet of the given data flow. The filter circuitry 614 may then identify the specified request, along with the corresponding flow identification information included with the data packet.

The flow encapsulation circuitry 616 is connected to the filter circuitry 614, to receive the copy of the selected data flow and re-encapsulate the selected data flow with new flow identification information. The flow encapsulation circuitry 616 outputs the re-encapsulated data flow (e.g., tFID) via the flow-mirroring port (fm.PortN). According to an embodiment, the re-encapsulated data flow is fed back into the switch circuitry 612 (e.g., at Port4) to be transmitted over the network (e.g., via PortN, with the data traffic from Ports1-3). For example, the new flow identification information may identify a test apparatus, connected to the network, as the destination for all data packets belonging to the re-encapsulated data flow. Alternatively, the new flow identification information may correspond to any type of provisioning information which may be used to direct (e.g., forward and/or route) the re-encapsulated data flow to its destination (e.g., the test apparatus). Examples of such new flow identification information may include, but are not limited to: an IP addresses, a MAC address, VLAN information, and or PBT or other tunneling information.

It should be noted that, in certain embodiments, the filter circuitry 614 may be configured to selectively output copies of multiple data flows. Accordingly, the flow encapsulation circuitry 616 may re-encapsulate all of the data flows with the same flow identification information (e.g., tFID). Alternatively, however, the flow encapsulation circuitry 616 may re-encapsulate each of the copied data flows, received from the filter circuitry 614, with different flow identification information.

It will be appreciated that the network switch 610 may provide advantages over the network switch 320 of FIG. 3. For example, the re-encapsulation of a selected data flow (to be monitored) may further limit a network administrator's access to only the selected data flow, thus providing an additional layer of privacy for all other data traffic on the network.

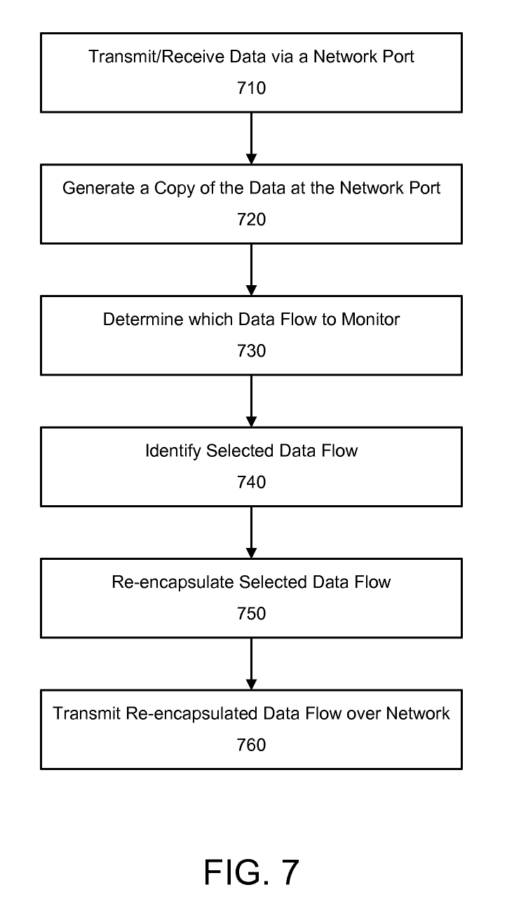

FIG. 7 illustrates an operation of a network switch, according to another embodiment. At 710, data traffic is transmitted and/or received over a network infrastructure, via a network port of the switch. At 720, the network switch generates a copy of the data traffic at the given network port. It should be noted that the incoming and/or outgoing data may be copied as soon as it is presented at the network port (i.e., steps 710 and 720 may be performed concurrently).

Then at 730, the network switch determines which data flow, of the copied data traffic, to monitor. According to an embodiment, the network switch may be manually configured to monitor a given data flow. According to another embodiment, the network switch may identify a request to monitor a particular data, along with corresponding flow identification information, flow from a data packet within the data flow (to be monitored) itself.

At 740, the network switch identifies the selected data flow from the copied data traffic, and outputs a copy of only those data packets associated with the selected data flow at 750. For example, the network switch may parse each of the copied data packets for the specified flow identification information (e.g., IP address, MAC address, VLAN information, and/or tunneling information) and/or filter all of the copied data packets not having the particular flow identification information. It should be noted, however, that the order in which data is copied or filtered may be arbitrary.

At 750, the network switch re-encapsulates the copy of the selected data flow with new flow identification information. For example, the new flow identification information may correspond to any type of provisioning information which may be used to direct (e.g., forward and/or route) the re-encapsulated data flow to a specified destination (e.g., a test apparatus). According to an embodiment, the network switch may dynamically assign the new flow identification information to the selected data flow. Alternatively, the selected data flow may be automatically re-encapsulated with the new flow identification information based on a data port, of the network switch, into which it is fed back (e.g., for transmission over the network). It should be noted that each data packet belonging to the selected data flow may be encapsulated with the new flow identification information. Furthermore, the new flow identification information may be written to each data packet in place of, or in addition to, the existing flow identification information.

The re-encapsulated data flow is then transmitted over the network, at 760. As mentioned above, the re-encapsulated data flow may be fed back into a data port of the network switch, and thus multiplexed onto a network port of the network switch to be transmitted along with multiple other data flows. Alternatively, however, the re-encapsulated data flow may be output via a separate network port, and thus transmitted across different network segments (e.g., dedicated for transmission of data to be monitored).

It should be noted that the various integrated circuits, dice and packages disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the present invention. In some instances, the terminology and symbols may imply specific details that are not required to practice the invention. For example, any of the specific numbers of bits, signal path widths, signaling or operating frequencies, component circuits or devices and the like may be different from those described above in alternative embodiments. In other instances, well-known circuits and devices are shown in block diagram form to avoid obscuring the present invention unnecessarily. Additionally, the interconnection between circuit elements or blocks may be shown as buses or as single signal lines. Each of the buses may alternatively be a single signal line, and each of the single signal lines may alternatively be buses. Signals and signaling paths shown or described as being single-ended may also be differential, and vice-versa. Similarly, signals described or depicted as having active-high or active-low logic levels may have opposite logic levels in alternative embodiments. Component circuitry within integrated circuit devices may be implemented using metal oxide semiconductor (MOS) technology, bipolar technology or any other technology in which logical and analog circuits may be implemented. With respect to terminology, a signal is said to be “asserted” when the signal is driven to a low or high logic state (or charged to a high logic state or discharged to a low logic state) to indicate a particular condition. Conversely, a signal is said to be “deasserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or deasserts, if explicitly stated or indicated by context) the signal on a signal line coupled between the signal driving and signal receiving circuits. A signal line is said to be “activated” when a signal is asserted on the signal line, and “deactivated” when the signal is deasserted. The term “coupled” is used herein to express a direct connection as well as a connection through one or more intervening circuits or structures. Integrated circuit device “programming” may include, for example and without limitation, loading a control value into a register or other storage circuit within the device in response to a host instruction and thus controlling an operational aspect of the device, establishing a device configuration or controlling an operational aspect of the device through a one-time programming operation (e.g., blowing fuses within a configuration circuit during device production), and/or connecting one or more selected pins or other contact structures of the device to reference voltage lines (also referred to as strapping) to establish a particular device configuration or operation aspect of the device. The term “exemplary” is used to express an example, not a preference or requirement.

While the invention has been described with reference to specific embodiments thereof, it will be evident that various modifications and changes may be made thereto without departing from the broader spirit and scope. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

What is claimed is:

1. A network switch comprising:
a first port to communicate a plurality of data items over a network, each of the plurality of data items being associated with one of a plurality of data flows;
a plurality of data ports switchably coupled to the first port to enable the plurality of data items to be communicated between the first port and at least one of the plurality of data ports; and
a second port to selectively output a copy of one or more of the plurality of data items based, at least in part, on the associated data flows.

2. The network switch of claim 1 wherein each of the one or more copied data items, output via the second port is associated with a selected set of data flows.

3. The network switch of claim 1, further comprising:
port mirroring circuitry to generate a copy of the plurality of data items provided at the first port; and
filter circuitry coupled to receive the copied data items from the port mirroring circuitry and to selectively enable output of one or more of the copied data items, via the second port, based on the associated data flows.

4. The network switch of claim 3 wherein the filter circuitry is programmable.

5. The network switch of claim 3 wherein the filter circuitry is configured to identify the data flow associated with each of the copied data items based, at least in part, on flow identification information included in each of the copied data items.

6. The network switch of claim 5 wherein the flow identification information includes at least one of: (i) an Internet Protocol (IP) address, (ii) a Media Access Control (MAC) address, (iii) Virtual Local Area Network (VLAN) information, or (iv) tunneling information.

7. The network switch of claim 3, further comprising flow encapsulation circuitry coupled to receive the one or more copied data items from the filter circuitry and to encapsulate the one or more copied data items with new flow identification information.

8. The network switch of claim 7 wherein the new flow identification information identifies a first device coupled to the network, and wherein the network switch is configured to transmit the one or more copied data items to the first device.

9. The network switch of claim 8 wherein the second port is coupled to provide the one or more copied data items, having the new flow identification information, to one of the plurality of data ports.

10. The network switch of claim 9 wherein the new flow identification information comprises at least one of: (i) an IP address, (ii) a MAC address, (iii) VLAN information, or (iv) tunneling information.

11. A method of operation within a network switch, the method comprising:
communicating a plurality of data items between a network and a first set of devices, each of the plurality of data items being associated with one of a plurality of data flows;
generating a copy of at least some of the plurality of data items; and
selectively outputting one or more of the copied data items based, at least in part, on the associated data flows.

12. The method of claim 11 wherein the one or more copied data items is associated with a selected set of data flows.

13. The method of claim 11 wherein selectively outputting one or more of the copied data items comprises identifying the data flow associated with each of the copied data items based, at least in part, on flow identification information included in each of the copied data items.

14. The method of claim 13 wherein the flow identification information includes at least one of: (i) an IP address, (ii) a MAC address, (iii) VLAN information, or (iv) tunneling information.

15. The method of claim 13 wherein selectively outputting one or more of the copied data items further comprises encapsulating the one or more copied data items with new flow identification information.

16. The method of claim 15 wherein encapsulating the one or more copied data items comprises determining the new flow identification information based, at least in part, on a first device coupled to the network, the first device being designated to receive the one or more copied data items.

17. The method of claim 16 further comprising transmitting the one or more copied data items, via the network, to the first device.

18. The method of claim 17 wherein transmitting the one or more copied data items comprises multiplexing the one or more copied data items with the plurality of data items to be transmitted over the network.

19. The method of claim 15 wherein the new flow identification information includes at least one of: (i) an IP address, (ii) a MAC address, (iii) VLAN information, or (iv) tunneling information.

20. A network switch comprising:
means for communicating a plurality of data items between a network and a first set of devices, each of the plurality of data items being associated with one of a plurality of data flows;
means for generating a copy of at least some of the plurality of data items; and
means for selectively outputting one or more of the copied data items based, at least in part, on the associated data flows.

21. Computer-readable storage media comprising data adapted to cause the processor of a data processing device to operate upon a netlist, the netlist including:
a first port to communicate a plurality of data items over a network, each of the plurality of data items being associated with one of a plurality of data flows;
a plurality of data ports coupled to a set of devices, wherein each of the plurality of data ports is switchably coupled to the first port to enable communication of the plurality of data items between the network and the set of devices; and
a second port to selectively output a copy of one or more of the plurality of data items based, at least in part, on the associated data flows.
